(19) United States
(12) Patent Application Publication
(10) Pub. No.: US 2024/0335787 A1
(43) Pub. Date: Oct. 10, 2024

(54) CO2 EXTRACTION FROM A MIXTURE OF GASES

(71) Applicant: Hans Gude GUDESEN, Luzern (CH)

(72) Inventor: Hans Gude GUDESEN, Luzern (CH)

(21) Appl. No.: 18/575,802

(22) PCT Filed: Jun. 30, 2022
(86) PCT No.: PCT/NO2022/050158

§ 371 Date: Dec. 29, 2023

(30) Foreign Application Priority Data
Jul. 2, 2021 (NO) 20210864

(51) Int. Cl. B01D 53/14

(52) U.S. Cl. CPC B01D 53/1475; B01D 2252/103; B01D 2257/504; B01D 2258/0283

(57) ABSTRACT

A method for extracting CO2 from a gas mixture comprising CO2 is disclosed. The method comprises dispensing the gas mixture in water in a first water volume, dissolving CO2 in the first water volume resulting in water enriched in dissolved 5CO2, and passing the water enriched in dissolved CO2 through a turbine. A corresponding system is also disclosed.

### FIELD OF THE INVENTION

The present invention generally relates to a method for selectively separating CO₂ gas from a mixture of gases containing N₂, O₂ as well as other gases in trace amounts, and systems for carrying out the method. It also includes methods and systems for recovering the CO₂ that has been separated from the other gases.

### BACKGROUND OF THE INVENTION

Emissions of CO₂ into the atmosphere from human activities are generally acknowledged as a major unsolved problem both locally where concentrations of CO₂ may become high and cause acute damage to flora and fauna, and on a global scale where the background concentration of CO₂ in the air is steadily rising, causing global warming and destruction of marine habitats. To meet this challenge, great efforts have been spent worldwide to capture and dispose of CO₂, in particular from high volume point emitters such as fossil fueled power plants, cement factories and garbage incinerators. However, the technical solutions that have emerged so far are far from satisfactory. A prominent example is the amine process where CO₂ is separated from flue gases, followed by compression, long distance transport and sequestration in cavities deep underground (see, e.g.: https://ccsnorway.com/capture-studies/). These processes are very energy consuming and expensive, carrying their own significant carbon footprints.

There is thus a pressing need to develop low cost, high capacity solutions that are capable of extracting CO₂ from relevant gas mixtures and delivering it in a form that facilitates long term sequestration or makes it suited as a feedstock in industrial processes.

U.S. Pat. No. 4,576,615 A “Carbon dioxide hydrocarbons separation process” discloses separation of carbon dioxide from light hydrocarbons such as methane and ethane by absorbing CO2 gas with water at a pressure of at least 500 psia thus avoiding the CO2-C2H6 azeotrope problem. The CO2 is recovered from the absorbing water by pressure reduction and flashing and/or by heating and flashing.

U.S. Pat. No. 4,566,278 A “Methane-carbon dioxide scrubbing method and system” discloses a thermodynamic method and system for up-grading the quality of digester methane gas by removing substantially all of the non-combustible carbon dioxide gas from the digester gas in a scrubbing system operated by the waste heat of an internal combustion engine utilizing the up-graded methane gas as its fuel source and driving a generator to produce electric power.

Kohl A. L. et al., “Gas Purification, passage”, Jan. 1, 1997, Gas Purification, Gulf Publishing Company, Houston Texas, pages 427 and 438, presents a simple water-wash process for carbon dioxide removal.

### SUMMARY OF THE INVENTION

A first aspect of the invention is a method for extracting CO2 from a gas mixture comprising CO2, where the method comprises dispensing the gas mixture in water in a first water volume, dissolving CO2 in the first water volume resulting in water enriched in dissolved CO2, and passing the water enriched in dissolved CO2 through a turbine into a recipient causing the CO2 enriched water experience a pressure drop, thereby eliciting flashing of the dissolved CO2 into gas phase and leaving degassed water at the lower part of the recipient.

Optionally, the method comprises venting the gas volume of the recipient allowing the flashed CO2 gas exiting the gas volume.

Optionally, the dispensing of the gas mixture is performed at a depth in the first water volume by bubbling in a liquid counterflow configuration.

Optionally, the dispensing of the gas mixture comprises mixing of the gas mixture and water in a mixing unit containing a part of the first water volume where optionally the mixing unit is employing one or more of the following: Counterflow bubbling columns, gas and water-fed Venturi bubble generators, water agitation in gas atmosphere (spray, mist, trompe), and gas diffusion through permeable membrane.

Optionally, the method comprises pumping degassed water out of the recipient through a second water volume, leading the gas mixture through a tube via a heat exchanger arranged in the second water volume where temperature of the gas mixture is higher than temperature of water in the second water volume thereby contributing to lifting of degassed water, and thereafter dispensing the gas mixture transported in the tube in the first water volume.

Optionally, the method comprises feeding water emanating from the second water volume into the first water volume thus forming a recirculating loop, and further optionally, the method comprises cooling the water emanating from the second water volume before feeding into the first water volume.

Optionally, the method comprises balancing bubble rising speed against descent speed of water in the first water volume to achieve optimal separation of CO₂ from other gas mixture constituents.

Optionally, the gas mixture is a flue gas.

Another aspect of the invention is a system for extracting CO2 from a gas mixture comprising CO2, where the system comprises means for dispensing the gas mixture in water in a first water volume causing CO2 to be dissolved resulting in water enriched in dissolved CO2, and a turbine arranged in fluidal connection with the first water volume allowing for passing of the water enriched in dissolved CO2 into a recipient, causing the CO2 enriched water to experience a pressure drop, thereby eliciting flashing of the dissolved CO2 into gas phase and leaving degassed water at the lower part of the recipient.

Optionally, the system comprises a venting tube arranged for venting the gas volume of the recipient allowing the flashed CO2 gas exiting the gas volume.

Optionally, the recipient is arranged for collecting the degassed water in a lower part thereof.

Optionally, the means for dispensing of the gas mixture is arranged at a depth in the first water volume by bubbling in a liquid counterflow configuration.

Optionally, the means for dispensing of the gas mixture comprises a mixing unit arranged for containing a part of the first water volume and arranged for mixing of the gas mixture and water, where optionally the mixing unit is arranged for employing one or more of the following: Counterflow bubbling columns, gas and water-fed Venturi bubble generators, water agitation in gas atmosphere (spray, mist, trompe), and gas diffusion through permeable membrane.

Optionally, the system comprises a pump arranged for pumping degassed water out of the recipient through a second water volume, a tube arranged for leading the gas mixture, a heat exchanger arranged in the second water column and connected to the tube for leading the gas mixture therethrough, where temperature of the gas mixture is higher than temperature of water in the second water volume, thereby contributing to lifting degassed water, and thereafter to the means for dispensing the gas mixture in the first water volume.

Optionally, the system comprises means for feeding water emanating from the second water volume into the first water volume thus forming a recirculating loop.

Optionally, the system comprises means for cooling the water emanating from the second water volume before feeding into the first water volume.

### DESCRIPTION OF THE FIGURES

The above and further features of the invention are set forth with particularity in the appended claims and together with advantages thereof will become clearer from consideration of exemplary embodiments of the invention given with reference to the accompanying drawings.

Embodiments of the present invention will now be described, by way of example only, with reference to the following figures, wherein:

FIG. 1 shows an embodiment based on a continuous counterflow system.

FIG. 2 shows an alternative embodiment of the present invention.

### LIST OF REFERENCE NUMBERS IN THE FIGURES

The following reference numbers refer to the drawings:
Number Designation
1 Flue gas
2 Tube
3 Water
4 First water-filled column
5 Dispersion device
6 Bubbles
7 Surface
8 Water
9 CO₂ enriched water
10 Turbine
11 Volume
12 Tube
13 Degassed water
14 Recipient
15 Pump
16 Second water-filled column
17 Top of column
18 Flashed gas
19 Heat exchanger
20 Water
21 Flue gas laden water
22 Water
23 Mixing unit.

### DESCRIPTION OF PREFERRED EMBODIMENTS OF THE INVENTION

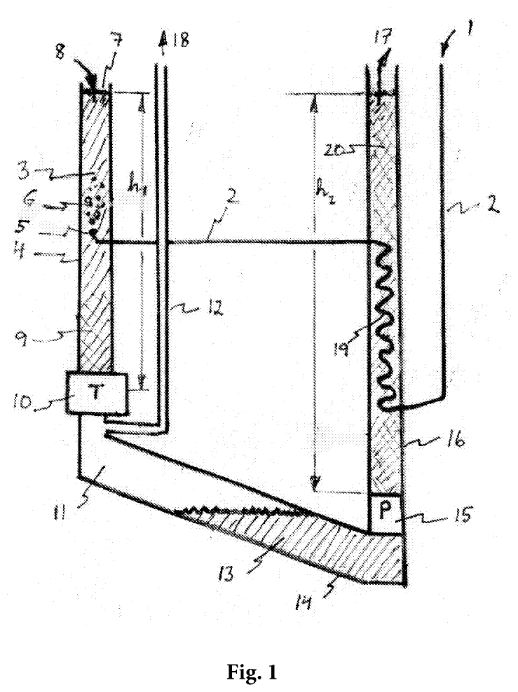

The present invention exploits differences in the solubility of gases in water to obtain separation of gases in a gas mixture. This is achieved in a high throughput process where the gas mixture is brought into contact with water across a large contact area, causing the gas species with the highest solubility to dominate gas transfer into the water phase. The remaining gas species with lower solubility are dissolved to a smaller degree and are subsequently separated out by mechanical means. For concreteness, it shall be assumed in the following that the gas mixture is flue gas from a combustion process. Three species are of particular interest, namely N₂, O₂ and CO₂, whose relative concentrations may be typically 70-80%, 2.5-4% and 1-25%, respectively. Generally, it is desired to separate the CO₂ from the other gaseous species. The solubilities in water for these gases are very different, which is exploited in the present invention: Under equilibrium conditions and at 10° C. and 1 bar partial pressure, the solubilities are respectively 0.019 g. N₂ gas per kg water, 0.057 g. O₂ gas per kg water, and 2.5 g. CO₂ gas per kg water. Thus, the solubility ratio is 44:1 between CO₂ and O₂ and 132:1 between CO₂ and N₂. At saturation, i.e. at long bubbling times, the water in the example shown in FIG. 1 shall have absorbed relative amounts of N₂, O₂ and CO₂ that differ from the composition of the flue gas. The CO₂ component shall typically be strongly enhanced in the water: It involves dissolved molecular CO₂ as well as carbonic acid, bicarbonate and carbonate and their reactions with cations present in the water. If one assumes that CO₂ is a simple gas, one can apply Henry's law which can be written:

cₐ=H^{cp}pₐ Eq.1

Here, H^{cp} is the Henry solubility constant, cₐ is the concentration of a species in the aqueous phase under equilibrium conditions and pₐ is the partial pressure of that species in the gas phase.

When CO₂ dissolves in water, the carbon enters a chain of interacting processes:

CO₂(gas)↔CO₂(liquid) Eq.2

CO₂(liquid)+H₂O↔H₂CO₃ Eq.3

H₂CO₃+H₂O↔H₃O⁺+HCO₃⁻ Eq.4

HCO₃+H₂O↔H₃O⁺+CO₃²⁻ Eq.5

Here, CO₂ (liquid) is carbon dioxide in solvated form in the water, H₂CO₃ is carbonic acid, HCO₃ is bicarbonate and CO₃²⁻ is carbonate. The relative concentrations of these species depend on the pH, with the dominant species at equilibrium and near-neutral pH being bicarbonate. The sum of these species is often referred to as dissolved inorganic carbon: DIC. The amount of DIC that can be absorbed in water depends on several factors, including the concentration and types of ionic species, as well as the temperature and CO₂ partial pressure. Thus, at 10 C and 1 bar CO₂ partial pressure, about 2.5 kg. of CO₂ can be accommodated in 1 m³ of water.

Some basic principles of the invention shall now be described with reference to FIG. 1:

The flue gas (1) is introduced via a tube (2) and brought into contact with water (3) in a first water-filled column (4) by a dispersion device (5). The dispersion device releases a cloud of bubbles (6) that exhibit a large contact area between the gases in the bubbles and the surrounding water. The bubbles tend to float upwards but encounter a downward flow of water inside the column (4). The gas transport out of the bubbles and into the water will differ between the gas species, reflecting differences in diffusivity and solubility in the water surrounding the bubble. This results in segregation of gas species where CO₂ which has the highest diffusivity and solubility is more easily transported into the water outside the bubble, while a larger proportion of the other gas species (e.g. N₂) remain inside the bubble and are transported out of the water volume when the bubble floats to the surface (7). Thus, a high degree of gas separation can be achieved by collecting the high solubility gas that has been dissolved in the water on the one hand and allowing the low solubility gas species to escape from the surface (7) on the other hand. Water (8) is continuously added at the top of the column and is enriched in dissolved CO₂ as it descends. Ultimately the CO₂ enriched water (9) passes through a turbine (10) which generates electrical power W:

$$W = V ρ {h}_{1} \qquad Eq . 6$$

Here V is the volumetric flow rate of water, p the average density of water in the column and h₁ the water column height. The water that passes through the turbine experiences a sudden pressure drop ΔP:

$$Δ P = ρ {gh}_{1} \qquad Eq . 7$$

as it exits into the volume (11) below, which communicates with the ambient atmosphere via the venting tube (12). This elicits flashing of the dissolved CO₂ into the gas phase and the flashed gas (18) exits through the venting tube (12). The degassed water (13) flows down into a recipient (14).

As can be recognized at this stage, CO₂ has been separated from the other flue gas components and brought into a water phase, energy has been generated in the turbine, water with the dissolved CO₂ has been degassed and the separated CO₂ has been brought out of the system in a separate venting tube (12). Experiments and analysis have shown that this procedure can deliver a separation efficiency exceeding 97% even with short columns (4) (less than 2 meters).

Further, the preferred embodiment shown in FIG. 1 includes an energy conservation feature as follows: A pump (15) transfers the degassed water (13) in the recipient (14) into a second water-filled column (16), causing water to be lifted in the column and exit at the top (17). Hot flue gas (1) is transported in the tube (2) through a heat exchanger (19) which transfers heat to the water (20) in the column (16). At relevant flue gas temperatures (120-180° C. and above) and depending on the local hydrostatic pressure the water experiences increasing temperatures and bubble formation by boiling. In either case, the density of the water is reduced, and ascending bubbles impart a pumping action on the water in the column. Depending on the overall system configuration, the energy required by the pump (15) to lift the head h₂ of water in column (16) shall be significantly lowered by the heat contribution from the flue gas.

An important feature of the system shown in FIG. 1 is that it opens up the possibility of closed cycle operation: Water emanating from the second column (16) at (17) may be fed into the first column (4) at (8), preferably following a cooling process, thus closing a recirculating loop. This removes the need for continuous access to large water resources.

The preferred embodiment illustrated in FIG. 1 exhibits certain additional beneficial features: First, the heat exchange that takes place in the column (16) lowers the temperature for the gas injected into the column (4) at (5) and avoids significant heating of the water (3), promoting dissolution of gas in the water and preserving high water density in column (4). Furthermore, the recipient (14) represents a buffer in the system promoting smooth operation. In cases where the volumetric capacity of the recipient (14) is large, the system may be used as a pumped hydroelectric energy storage facility.

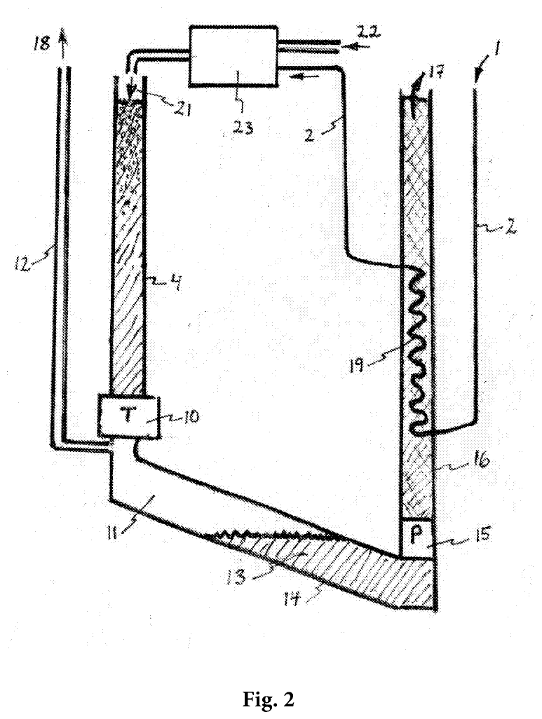

FIG. 2 shows another preferred embodiment which differs from the one shown in FIG. 1 by how flue gas is introduced into the water in the water-filled column (4): Instead of the counterflow configuration in FIG. 1 where bubbles are injected at depth in the column and rise against a descending stream of water, flue gas from the tube (2) and water (22) are brought together in the mixing unit (23). The flue gas laden water (21) from the mixing unit (23) is introduced at the top of column (4) and flows downwards in the column (4). The mixing unit (23) may be selected from a range of alternative types of systems that include counterflow bubbling columns, gas and water-fed Venturi bubble generators, gas dissolution based on agitated water in gas atmosphere (spray, mist, trompe), etc. Depending on the type of mixing unit used, the water (21) fed into the column (4) may contain bubbles as well as dissolved CO₂, where the bubble rising speed due to buoyancy is balanced against the descent speed of the water in the column (4) to achieve optimal separation of CO₂ from the other flue gas constituents.

1. A method for extracting CO2 from a gas mixture comprising CO2, where the method comprises:
dispensing the gas mixture in water in a first water volume;
dissolving CO2 in the first water volume resulting in water enriched in dissolved CO2;
passing the water enriched in dissolved CO2 through a turbine (10) into a recipient (14) causing the CO2 enriched water experience a pressure drop, thereby eliciting flashing of the dissolved CO2 into gas phase and leaving degassed water (13) at the lower part of the recipient (14); and
pumping degassed water out of the recipient through a second water volume, leading the gas mixture through a tube via a heat exchanger arranged in the second water volume where temperature of the gas mixture is higher than temperature of water in the second water volume thereby contributing to lifting of degassed water, and thereafter dispensing the gas mixture transported in the tube in the first water volume.

2. The method according to claim 1, comprising venting the gas volume (11) of the recipient (14) allowing the flashed CO₂ gas exiting the gas volume (11).

3. The method according to claim 1, where the dispensing of the gas mixture is performed at a depth in the first water volume by bubbling in a liquid counterflow configuration.

4. The method according to claim 1, where the dispensing of the gas mixture comprises mixing of the gas mixture and water in a mixing unit (21) containing a part of the first water volume.

5. The method according to claim 4, where the mixing unit is employing one or more of the following: Counterflow bubbling columns, gas and water-fed Venturi bubble generators, water agitation in gas atmosphere (spray, mist, trompe), and gas diffusion through permeable membrane.

6. (canceled)

7. The method according to claim 1, further comprising feeding water (17) emanating from the second water volume (16) into the first water volume thus forming a recirculating loop.

8. The method according to claim 7, further comprising cooling the water (17) emanating from the second water volume (16) before feeding into the first water volume.

9. The method according to claim 1, comprising balancing bubble rising speed against descent speed of water in the first water volume to achieve optimal separation of CO2 from other gas mixture constituents.

10. The method according to claim 1, where the gas mixture is a flue gas.

11. System A system for extracting CO2 from a gas mixture comprising CO2, where the system comprises:
means for dispensing the gas mixture in water in a first water volume causing CO2 to be dissolved resulting in water enriched in dissolved CO2;
a turbine (10) arranged in fluidal connection with the first water volume allowing for passing of the water enriched in dissolved CO2 into a recipient (14), causing the CO2 enriched water to experience a pressure drop, thereby eliciting flashing of the dissolved CO2 into gas phase and leaving degassed water (13) at the lower part of the recipient (14); and
a pump (15) arranged for pumping degassed water (13) out of the recipient (14) through a second water volume (16), a tube (2) arranged for leading the gas mixture (1), a heat exchanger (19) arranged in the second water column (20) and connected to the tube (2) for leading the gas mixture (1) therethrough, where temperature of the gas mixture is higher than temperature of water in the second water volume (20), thereby contributing to lifting degassed water (13), and thereafter to the means for dispensing the gas mixture in the first water volume.

12. The system according to claim 11, comprising a venting tube (12) arranged for venting the gas volume (11) of the recipient (14) allowing the flashed CO2 gas exiting the gas volume (11).

13. The system according to claim 11, where the recipient (14) is arranged for collecting the degassed water (13) in a lower part thereof.

14. The system according to claim 11, where the means for dispensing of the gas mixture is arranged at a depth in the first water volume by bubbling in a liquid counterflow configuration.

15. The system according to claim 11, where the means for dispensing of the gas mixture comprises a mixing unit arranged for mixing of the gas mixture and water.

16. The system according to claim 15, where the mixing unit is arranged for employing one or more of the following: Counterflow bubbling columns, gas and water-fed Venturi bubble generators, water agitation in gas atmosphere (spray, mist, trompe), and gas diffusion through permeable membrane.

17. (canceled)

18. The system according to claim 11, further comprising means for feeding water (17) emanating from the second water volume (16) into the first water volume thus forming a recirculating loop.

19. The system according to claim 18, further comprising means for cooling the water (17) emanating from the second water volume (16) before feeding into the first water volume.

20. The method according to claim 2, where the dispensing of the gas mixture is performed at a depth in the first water volume by bubbling in a liquid counterflow configuration.

21. The method according to claim 2, where the dispensing of the gas mixture comprises mixing of the gas mixture and water in a mixing unit.

22. The method according to claim 2, further comprising feeding water emanating from the second water volume into the first water volume thus forming a recirculating loop.
